(19) United States
(12) Patent Application Publication
(10) Pub. No.: US 2026/0253024 A1
(43) Pub. Date: Aug. 27, 2026

(54) INFORMATION PROCESSING SYSTEM, INFORMATION PROCESSING DEVICE, INFORMATION PROCESSING METHOD, AND PROGRAM

(71) Applicant: AERONEXT INC., Tokyo (JP)

(72) Inventors: Shuji KAWAI, Tokyo (JP); Tadanari HIGUCHI, Gifu (JP); Keisuke TOJI, Tokyo (JP); Takuya HORI, Tokyo (JP)

(21) Appl. No.: 18/879,225

(22) PCT Filed: Jun. 28, 2023
(86) PCT No.: PCT/JP2023/024020

§ 371 Date: Dec. 26, 2024

(30) Foreign Application Priority Data
Jun. 30, 2022 (JP) 2022-105544

(51) Int. Cl. G06Q 10/0836

(52) U.S. Cl. CPC G06Q 10/0836

(57) ABSTRACT

An information processing system includes a control unit that approves a candidate for a proxy who can pick up a package on behalf of a recipient designated in an address of the package, as the proxy, and an authentication unit that performs an authentication process of determining whether a request for pick-up authentication of the package that is delivered is a request from the proxy who is approved by the control unit.

### FIELD

The present invention relates to an information processing system, an information processing device, an information processing method, and a program.

### BACKGROUND

In recent years, package delivery services have come to use more and more kinds of delivery means, and technologies have been developed to handle a variety of delivery means. For example, Patent Literature 1 discloses a logistics management system that manages information about a logistics network and changes operation plans of a circular service circulating in an area on the basis of such information.

### CITATION LIST

### Patent Literature

Patent Literature 1: Japanese Patent Application Laid-open No. 2020-52525

### SUMMARY

### Technical Problem

As such package delivery means, unmanned vehicles capable of autonomous control, for example unmanned aircrafts such as drones and unmanned aerial vehicles (UAVs) and travel bodies such as unmanned ground vehicles (UGVs) have come to be used. If a package is kept by an unmanned vehicle, the unmanned vehicle cannot leave the area until the package is picked up. Therefore, a recipient designated in an address of the package desirably stands by at an arrival position at a timing when the unmanned vehicle arrives at the arrival position.

However, a sudden change in the recipient's schedule could prevent the recipient from standing by at the arrival point at the timing when the unmanned vehicle arrives.

The present invention has been made in view of the above problem, and an object of the present invention is to provide a novel and improved technology that enables a proxy, who is a representative of a recipient, to pick up a package smoothly.

### Solution to Problem

In order to solve the above problem, one aspect of the present invention provides an information processing system including: a control unit that approves a candidate for a proxy who is able to pick up a package on behalf of a recipient designated in an address of the package, as the proxy; and an authentication unit that performs an authentication process of determining whether a request for pick-up authentication of the package that is delivered is a request from the proxy who is approved by the control unit.

Moreover, in order to solve the above problem, another aspect of the present invention provides an information processing device including: a control unit that approves a candidate for a proxy who is able to pick up a package on behalf of a recipient designated in an address of the package, as the proxy; and an authentication unit that performs an authentication process of determining whether a request for pick-up authentication of the package that is delivered is a request from the proxy who is approved by the control unit.

In addition, in order to solve the above problem, still another aspect of the present invention provides an information processing method to be performed by a computer, the information processing method including: approving a candidate for a proxy who is able to pick up a package on behalf of a recipient designated in an address of the package, as the proxy; and performing an authentication process of determining whether a request for pick-up authentication of the package that is delivered is a request from the proxy who is approved.

Furthermore, in order to solve the above problem, yet another aspect of the present invention provides a program causing a computer to function as: a control unit that approves a candidate for a proxy who is able to pick up a package on behalf of a recipient designated in an address of the package, as the proxy; and an authentication unit that performs an authentication process of determining whether a request for pick-up authentication of the package that is delivered is a request from the proxy who is approved by the control unit.

### Advantageous Effects of Invention

As described above, the present invention enables smooth pick-up of a package by a proxy on behalf of a recipient.

### BRIEF DESCRIPTION OF DRAWINGS

FIG. 1 is an explanatory diagram of an overview of an information processing system according to the present invention.

FIG. 2 is an image diagram of approval and authentication of a proxy by a proxy authentication server 30 according to the present invention.

FIG. 3 is an explanatory diagram illustrating an internal structure of a recipient's terminal 10.

FIG. 4 is an explanatory diagram illustrating an internal structure of a proxy's terminal 20.

FIG. 5 is an explanatory diagram illustrating an internal structure of the proxy authentication server 30.

FIG. 6 is a diagram illustrating an example of a database stored in a storage unit 320.

FIG. 7 is a diagram illustrating an example of a notification of a proxy recruitment transmitted to the proxy's terminal 20.

FIG. 8 is an explanatory diagram illustrating an internal structure of a keeping device 40.

FIG. 9 is an explanatory diagram for describing an example of a procedure of operation processing of proxy approval by the proxy authentication server 30 according to the present embodiment.

FIG. 10 is an explanatory diagram for describing an example of a procedure of operation processing of an authentication process by the proxy authentication server 30 according to the present embodiment.

FIG. 11 is an explanatory diagram for describing an example of a hardware configuration of the proxy authentication server 30 according to the present embodiment.

### DESCRIPTION OF EMBODIMENTS

The contents of embodiments of the present invention will be listed and described. An information processing system and the like according to the embodiments of the present invention include the following configurations.

### Item 1

An information processing system including:
a control unit that approves a candidate for a proxy who is able to pick up a package on behalf of a recipient designated in an address of the package, as the proxy; and
an authentication unit that performs an authentication process of determining whether a request for pick-up authentication of the package that is delivered is a request from the proxy who is approved by the control unit.

### Item 2

The information processing system according to item 1, further including a communication unit that receives a notification as to whether proxy pick-up of the package is possible from an information processing terminal used by the candidate for the proxy.

### Item 3

The information processing system according to item 2, in which when the communication unit receives the notification that pick-up of the package is possible from the information processing terminal used by the candidate for the proxy, the control unit approves the candidate for the proxy as the proxy.

### Item 4

The information processing system according to item 2 or 3, in which the communication unit receives designation information that is designation of the candidate for the proxy from an information processing terminal used by the recipient.

### Item 5

The information processing system according to item 2 or 3, in which the communication unit transmits a proxy request to ask for proxy pick-up of the package designated by the recipient.

### Item 6

The information processing system according to item 2 or 3, in which the communication unit transmits information about the package to the information processing terminal used by the candidate for the proxy.

### Item 7

The information processing system according to item 5, further including a storage unit that stores therein one or a plurality of candidates for the proxy set in advance by the recipient, in which
the communication unit transmits the proxy request to ask the candidate for the proxy stored in the storage unit to pick up the package by proxy.

### Item 8

The information processing system according to item 7, in which the communication unit transmits the proxy request to the candidate for the proxy selected by the recipient, among the candidates for the proxy stored in the storage unit.

### Item 9

The information processing system according to item 2 or 3, in which upon reception of a proxy support request from the information processing terminal used by the recipient, the communication unit transmits a notification of proxy recruitment to the information processing terminal used by the candidate for the proxy.

### Item 10

The information processing system according to item 9, in which the communication unit transmits the notification of the proxy recruitment including reward information to the candidate for the proxy.

### Item 11

The information processing system according to item 9, in which the communication unit receives positional information of the candidate for the proxy, and transmits the notification of the proxy recruitment to the candidate for the proxy in accordance with the positional information.

### Item 12

The information processing system according to item 9, in which in a case where the proxy needs to pick up the package from an unmanned aircraft, the communication unit transmits the notification of the proxy recruitment to a person who has taken a predetermined training session.

### Item 13

The information processing system according to item 1 or 2, in which when the authentication by the authentication unit is determined to be a success, the control unit controls so that the package is able to be taken out of a keeping device that keeps the package.

### Item 14

The information processing system according to item 13, in which
the keeping device is an unmanned vehicle, and
when the authentication by the authentication unit is determined to be a success, the control unit controls so that the package is able to be taken out of the unmanned vehicle.

### Item 15

The information processing system according to item 13, in which the keeping device keeps the package released from the unmanned vehicle.

### Item 16

The information processing system according to item 13, in which
the authentication unit is included in the keeping device,
the keeping device further includes an authentication communication unit, and
the authentication communication unit receives information about the authentication from the information processing terminal used by the proxy.

### Item 17

The information processing system according to item 2 or 3, in which
the communication unit receives identification information transmitted from the information processing terminal used by the proxy, and
the authentication unit performs authentication, based on the identification information.

### Item 18

The information processing system according to item 13, in which the authentication unit authenticates the proxy in response to an authentication request from the information processing terminal used by the proxy, based on identification information related to the keeping device.

### Item 19

The information processing system according to item 2 or 3, in which when the authentication by the authentication unit is determined to be a success, the communication unit transmits a notification of authentication completion to an information processing terminal used by a person who manages the package.

### Item 20

The information processing system according to item 2 or 3, in which upon the authentication by the authentication unit, the communication unit notifies the recipient of a result of the authentication.

### Item 21

An information processing device including:
a control unit that approves a candidate for a proxy who is able to pick up a package on behalf of a recipient designated in an address of the package, as the proxy; and an authentication unit that performs an authentication process of determining whether a request for pick-up authentication of the package that is delivered is a request from the proxy who is approved by the control unit.

### Item 22

An information processing method to be performed by a computer, the information processing method including:
approving a candidate for a proxy who is able to pick up a package on behalf of a recipient designated in an address of the package, as the proxy; and
performing an authentication process of determining whether a request for pick-up authentication of the package that is delivered is a request from the proxy who is approved.

### Item 23

A program causing a computer to function as:
a control unit that approves a candidate for a proxy who is able to pick up a package on behalf of a recipient designated in an address of the package, as the proxy; and
an authentication unit that performs an authentication process of determining whether a request for pick-up authentication of the package that is delivered is a request from the proxy who is approved by the control unit.

Preferred embodiments of the present invention will hereinafter be described in detail with reference to the accompanying drawings. In the present specification and drawings, duplicate explanations of components having substantially identical functional configuration will be omitted by applying the same reference signs thereto.

In the present specification and the drawings, a plurality of components with substantially the same functional configuration may be distinguished by the same reference sign followed by different alphabets. However, when there is no particular need to distinguish between the components that have substantially the same functional configuration, just the same reference sign is given to each of the components.

### 1. Overview of Information Processing System According to One Embodiment of Present Invention

First, an overview of an information processing system in the embodiment of the present invention is described. This information processing system enables a proxy, who is a representative of a recipient, to pick up a package smoothly.

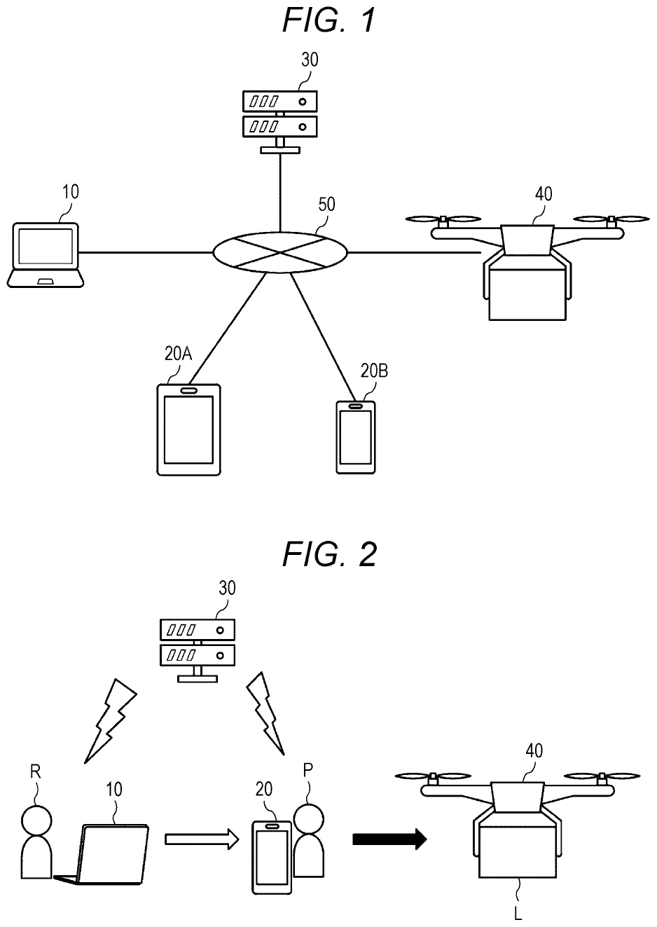

FIG. 1 is an explanatory diagram of an overview of the information processing system according to the present invention. As illustrated in FIG. 1, the information processing system according to the present invention includes a recipient's terminal 10, a proxy's terminal 20, a proxy authentication server 30, a keeping device 40, and a network 50. As illustrated in FIG. 1, the recipient's terminal 10, the proxy's terminal 20, the proxy authentication server 30, and the keeping device 40 are configured to be able to communicate with each other via the net work 50.

The recipient's terminal 10 is an information processing terminal used by the recipient designated in an address of the package. The recipient's terminal 10 transmits designation information, which is the designation of a candidate for a proxy who can pick up the package on behalf of the recipient, to the proxy authentication server 30.

The recipient, for example, designates a specific person as the candidate for the proxy. This allows the recipient to ask the designated specific person to pick up the package on his/her behalf. The specific person is desirably a suitable person to pick up the package on behalf of the recipient, for example, a family member, a friend, a manager in charge of a departure and arrival point for a mobile body that delivers the package, or an organizer of a neighborhood association. The designation information may be information that designates the type of the candidate for the proxy or may be information that represents the identification information of a specific candidate for the proxy.

The recipient's terminal 10 also transmits a proxy support request to the proxy authentication server 30, requesting the person indicated in the designation information to support the package pick-up by proxy. The recipient's terminal 10 can have the proxy authentication server 30 recruit a proxy by transmitting the proxy support request. The proxy support request may be transmitted simultaneously to the persons indicated in the designation information with reference to the designation information, or may be transmitted for each proxy candidate type in the order indicated by priority order information, which is related to the designation information and set in advance by the recipient, with reference to the priority order information. If the proxy support request is transmitted in order for each proxy candidate type, the proxy support request may be transmitted sequentially each time a predetermined deadline period elapses. The deadline period information may be set individually for each proxy candidate type, or may be set in common.

The proxy's terminal 20 is an information processing terminal used by the candidate for the proxy or the proxy (who can technically be a candidate for the proxy until he/she is confirmed as the proxy, but is sometimes referred to collectively as a proxy). The proxy's terminal 20 receives a proxy request to ask for the pick-up of the package by proxy, and a notification of the proxy recruitment from the proxy authentication server 30. In addition, the proxy's terminal 20 transmits a notification to the proxy authentication server 30 as to whether the proxy pick-up of the package is possible by an approval operation on the application, etc.

The proxy's terminal 20 also transmits an authentication request to the proxy authentication server 30, which is a request for the pick-up authentication of the delivered package.

The recipient's terminal 10 and the proxy's terminal 20 are, for example, information processing terminals such as a personal computer, a tablet terminal, a smartphone, a cellular phone, a personal handy-phone system (PHS), and a personal digital assistant (PDA). In the example illustrated in FIG. 1, the recipient's terminal 10 is a personal computer, a proxy's terminal 20A is a tablet terminal, and a proxy's terminal 20B is a smartphone.

The proxy authentication server 30 is an example of an information processing device and is a server that performs an authentication process to determine whether a request for the pick-up authentication of a delivered package is authenticated by an approved proxy. For example, the proxy authentication server 30 may be a general-purpose computer, such as a workstation or PC, or may be a cloud server.

Upon the reception of the designation information, which is the designation of the candidate for the proxy from the recipient's terminal 10 (or with reference to the previously received designation information), the proxy authentication server 30 transmits a proxy request to the proxy's terminal 20 used by that candidate for the proxy.

In addition, upon the reception of the proxy support request from the recipient's terminal 10, the proxy authentication server 30 selects the candidate for the proxy. Subsequently, the proxy authentication server 30 transmits a notification of the proxy recruitment to the proxy's terminal 20 used by the selected candidate for the proxy. Upon the reception of the notification from the proxy's terminal 20 that the proxy pick-up of the package is possible, the proxy authentication server 30 approves the candidate for the proxy who uses that proxy's terminal 20, as the proxy.

Moreover, upon the reception of the authentication request from the proxy's terminal 20, the proxy authentication server 30 performs an authentication process to determine whether the request for the pick-up authentication of the delivered package is authenticated by the approved proxy. If it is determined that the request is from the proxy, i.e., the authentication is successful, the proxy authentication server 30 controls the keeping device 40 so that the package can be taken out of the keeping device 40. Thus, people other than the approved proxy cannot take the package of the recipient, so that the risk of package theft can be reduced. Note that the authentication request is not limited to being received from the proxy's terminal 20 and may be transmitted from the keeping device 40 to the proxy authentication server 30 after transmission of identification information for authentication (for example, package identification information, delivery identification information, user identification information, proxy identification information, or the like), such as an authentication code, from the proxy's terminal 20 to the keeping device 40. Alternatively, the authentication request from the keeping device 40 is received or the proxy request from the recipient's terminal 10 is received so that the keeping device 40 acquires the authentication information in advance. Then, the authentication process may be performed at the keeping device 40. All of these are examples and the present invention is not limited thereto.

The keeping device 40 is a device capable of keeping packages. The keeping device 40 is not limited in particular as long as the packages can be kept. The keeping device 40 may be an unmanned vehicle that moves based on autonomous control using input information about positions regarding the package delivery, for example, two positions of a start point (for example, a delivery start position of a package L or a moving start position of an unmanned vehicle 10B) and an end point (for example, a pick-up position of the package L), or three or more positions of further including a relay point (for example, in a case of delivery with collection of the package L, a collection position of the package L) or a return point (for example, the same position as the moving start position of the unmanned vehicle 10, or a different stand-by position, etc.). The keeping device 40 may be an unmanned vehicle that moves by a remote operation using operation information remotely operated and input by a manager who manages the unmanned vehicle.

The unmanned vehicle may be, for example, a drone that moves based on autonomous control, an unmanned aerial vehicle (UAV) that moves by a remote operation by a manager, a vehicle that moves in a land route, such as an unmanned ground vehicle (UGV), or a ship that moves on water in a sea route, a river route, or the like. The unmanned vehicle may alternatively be a mobile body that can move in at least two or more routes of a land route, a water route, and an air route.

The unmanned vehicle may alternatively be a mobile body that can move in at least two or more routes of a land route, a water route, and an air route.

The keeping device 40 may be a delivery box that is installed outdoors and can accommodate the delivered package. The delivery box may keep the package released from the unmanned vehicle and preferably has a mechanism to automatically take the package into the delivery box especially for the unmanned vehicle 10B. The keeping device 40 may be a storage unit that is delivered at the same time as the package and detached from the unmanned vehicle, or a storage device with an electronic lock in which the package is accommodated. When it is determined that the authentication is successful by the proxy authentication server 30, the keeping device 40 enables the kept package to be taken out, based on the control by the proxy authentication server 30. If the delivery box has an electronic lock function, the storage unit in which the package is accommodated may be unlocked based on information about the unlock transmitted from the proxy authentication server 30 to the proxy's terminal 20. The information about the unlock may be an unlock code, the proxy may directly operate the storage box and enter the unlock code, or the proxy's terminal 20 may enter the unlock code by communication.

The network 50 is a wired or wireless transmission path for information transmitted from devices connected to the network 50. For example, the network 50 may include a public network such as the Internet, a telephone network, or a satellite communication network, various local area networks (LANs) including Ethernet (registered trademark), or a wide area network (WAN). The network 50 may also include a leased line network such as Internet protocol-virtual private network (IP-VPN).

FIG. 2 is an image diagram of the approval and the authentication of the proxy by the proxy authentication server 30 according to the present invention. A recipient R transmits the designation of a candidate for a proxy, who is a candidate for a proxy P, or a proxy support request using the recipient's terminal 10. The candidate for the proxy who has transmitted the notification to the proxy authentication server 30 that the pick-up of the package L is possible is approved by the proxy authentication server 30 as the proxy P. The approved proxy P picks up the package L from the keeping device 40 after the authentication by the proxy authentication server 30.

Note that the delivery means of the package L is not limited in particular. For example, the delivery means of the package L may be a manned mobile body such as a vehicle that moves in a land route, an aircraft that flies in an air route, or a ship that moves on water in a sea route, a river route, or the like. The delivery means of the package L may be the unmanned vehicle as described above.

The delivery means of the package L and the keeping device 40 may be either the same unmanned vehicle or different unmanned vehicles.

### 2. Example of Functional Configuration in Present Embodiment

### 2-1. Example of Functional Configuration of Recipient's Terminal 10

The overview of the information processing system according to the embodiment of the invention has been described above. Next, an example of the functional configuration of the recipient's terminal 10 is described.

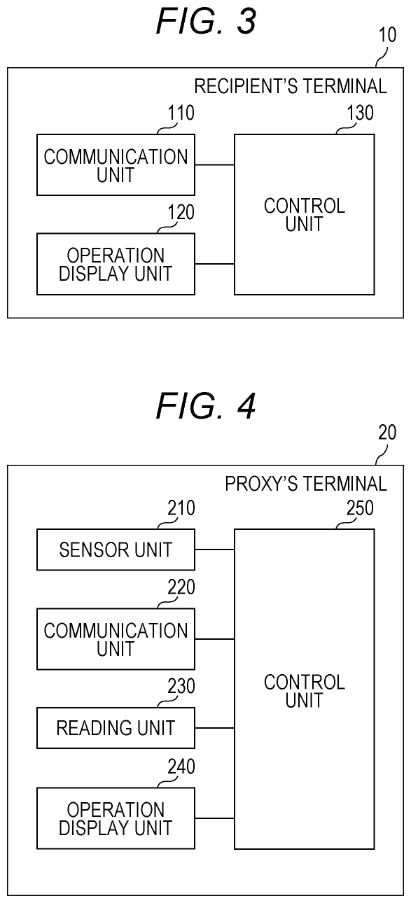

FIG. 3 is an explanatory diagram illustrating an internal structure of the recipient's terminal 10. As illustrated in FIG. 3, the recipient's terminal 10 includes a communication unit 110, an operation display unit 120, and a control unit 130.

### (Communication Unit)

The communication unit 110 communicates with and connects to the proxy authentication server 30 via the network 50 and transmits and receives data. For example, the communication unit 110 transmits the designation of the candidate for the proxy and the proxy support request to the proxy authentication server 30.

In addition, the communication unit 110 receives from the proxy authentication server 30, the information of the proxy P about the package L where the recipient R is designated in the address, such as the approval status of the proxy P about the package L and the result of the authentication by the proxy authentication server 30.

### (Operation Display Unit)

The operation display unit 120 encompasses a function as an operation unit, which is a structure that the recipient R operates to input an instruction or information into the recipient's terminal 10, and a function as a display unit, which displays various kinds of information according to the control by the control unit 130. For example, by operating the operation display unit 120, the recipient R causes the communication unit 110 to transmit the designation information or the proxy support request to the proxy authentication server 30.

By operating the operation display unit 120, the recipient R may designate, for each package L, the candidate for the proxy about that package L. The recipient R may also set one or more candidates for the proxy in advance by operating the operation display unit 120. In such a case, the recipient R may operate the operation display unit 120 so as to cause the communication unit 110 to transmit a notification to the proxy authentication server 30 to designate the preset one or more candidates for the proxy as the candidate or candidates for the proxy about the package L. This eliminates the complexity for the recipient R to designate the candidate for the proxy for each package L. The recipient R may also operate the operation display unit 120 to designate the candidate or candidates for the proxy about the package L by selecting a part of the preset candidates for the proxy.

The operation display unit 120 displays information transmitted from the proxy authentication server 30 to the communication unit 110, such as the approval status of the proxy P and the result of the authentication by the proxy authentication server 30.

### (Control Unit)

The control unit 130 controls the overall operation of the recipient's terminal 10. For example, the control unit 130 causes the communication unit 110 to transmit information such as the designation information or the proxy support request acquired by the operation display unit 120. The control unit 130 causes the operation display unit 120 to display the information received from the proxy authentication server 30 by the communication unit 110, such as the approval status of the proxy P and the result of the authentication by the proxy authentication server 30.

### 2-2. Example of Functional Configuration of Proxy's Terminal 20

The example of the functional configuration of the recipient's terminal 10 according to the embodiment of the present invention has been described above. Subsequently, an example of the functional configuration of the proxy's terminal 20 is described.

FIG. 4 is an explanatory diagram illustrating an internal structure of the proxy's terminal 20. As illustrated in FIG. 4, the proxy's terminal 20 includes a sensor unit 210, a communication unit 220, a reading unit 230, an operation display unit 240, and a control unit 250.

### (Sensor Unit)

The sensor unit 210 is a sensor that detects the current position of the proxy's terminal 20. The sensor unit 210 may detect the current position of the proxy's terminal 20 using a global navigation satellite system (GNSS), for example.

### (Communication Unit)

The communication unit 220 communicates with and connects to the proxy authentication server 30 via the network 50 and transmits and receives data. The communication unit 220 receives from the proxy authentication server 30, a proxy request to ask for the proxy pick-up of the package L and the notification of the proxy recruitment. The communication unit 220 notifies the proxy authentication server 30 of whether the proxy pick-up of the package L input in the operation display unit 240 is possible. The communication unit 220 transmits the positional information of the proxy's terminal 20 acquired by the sensor unit 210 to the proxy authentication server 30. The communication unit 220 also transmits the authentication request to the proxy authentication server 30. The authentication request includes the identification information read by the reading unit 230 related to the package L or the keeping device 40.

### (Reading Unit)

The reading unit 230 reads the identification information related to the package L or the keeping device 40. The reading unit 230 reads the identification information from various kinds of information codes, such as bar codes or two-dimensional codes printed on or displayed on a screen of the package L or the keeping device 40 with a camera or the like, for example. The reading unit 230 may also read various kinds of information codes affixed to the package L or the keeping device 40. The reading unit 230 is not limited to a camera, and may alternatively read the identification information of the package L or the keeping device 40 by, for example, a noncontact or contact type IC card reader or the like. The reading unit 230 may be a keyboard or other input device. In such a case, the proxy P inputs the string of characters displayed on the screen of, or printed on the package L or on the keeping device 40 into the input device as the identification information. The reading unit 230 may also read the external form of the package L or the keeping device 40. In such a case, the read external form is transmitted as an image to the proxy authentication server 30 by the communication unit 220, and the proxy authentication server 30 converts the image into the identification information through image recognition.

### (Operation Display Unit)

The operation display unit 240 encompasses a function as an operation unit, which the proxy P or the candidate for the proxy operates in order to input the instruction or the information to the proxy's terminal 20, and a function as a display unit, which displays various kinds of information according to the control by the control unit 250. For example, the operation display unit 240 displays the notification of the proxy request by the recipient R and the proxy recruitment that are transmitted from the proxy authentication server 30 to the communication unit 220. The candidate for the proxy also inputs whether the proxy pick-up of the package L is possible by operating the operation display unit 240.

### (Control Unit)

The control unit 250 controls the overall operation of the proxy's terminal 20. For example, the control unit 250 causes the communication unit 220 to transmit the notification, which is acquired by the operation display unit 240, as to whether the proxy pick-up of the package L is possible. The control unit 250 also causes the operation display unit 240 to display the information including the proxy request and the notification of the proxy recruitment that are received from the proxy authentication server 30 by the communication unit 220.

### 2-3. Example of Functional Configuration of Proxy Authentication Server 30

The example of the functional configuration of the proxy's terminal 20 according to the embodiment of the present invention has been described above. Next, an example of the functional configuration of the proxy authentication server 30 is described.

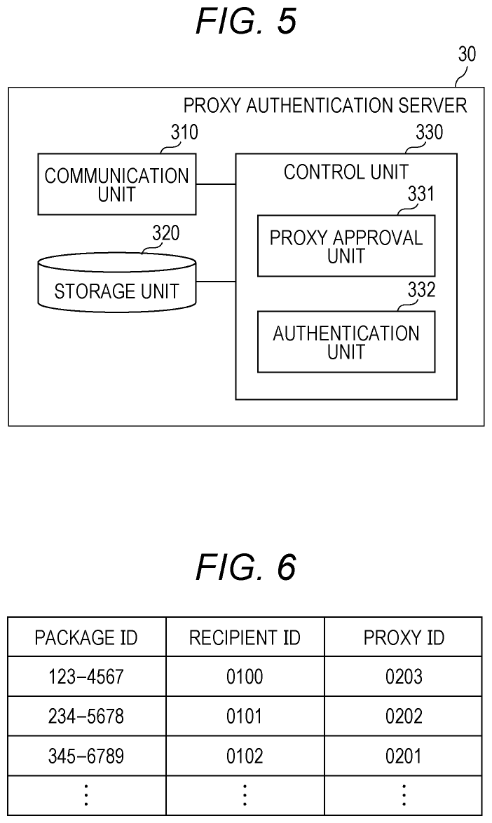

FIG. 5 is an explanatory diagram illustrating an internal structure of the proxy authentication server 30. As illustrated in FIG. 5, the recipient's terminal 10 includes a communication unit 310, a storage unit 320, and a control unit 330.

### (Communication Unit)

The communication unit 310 communicates with the recipient's terminal 10 and the proxy's terminal 20 via the network 50. For example, the communication unit 310 receives the designation information and the proxy request from the recipient's terminal 10. The communication unit 310 also transmits to the recipient's terminal 10, the approval status of the proxy P about the package L where the recipient R is designated in the address and the result of the pick-up authentication of the package L, etc. For example, upon the reception of the notification that the proxy pick-up is impossible from the proxy's terminal 20 (or when it is determined that a predetermined recruitment period has elapsed from the proxy's terminal 20 or when it is determined a predetermined recruitment deadline time has come, for example), the communication unit 310 transmits the notification that the proxy pick-up by the candidate for the proxy is impossible to the recipient's terminal 10.

The communication unit 310 also transmits to the proxy's terminal 20 used by the candidate for the proxy, the information stored in the storage unit 320 about the package L that can be picked up on behalf of the recipient R. The communication unit 310 also transmits the proxy request and the notification of the proxy recruitment to the proxy's terminal 20. The communication unit 310 receives the notification from the proxy's terminal 20 as to whether the proxy pick-up of the package L is possible. The communication unit 310 also receives the authentication request from the proxy's terminal 20.

### (Storage Unit)

The storage unit 320 stores therein programs and various kinds of data for operating the control unit 330. For example, the storage unit 320 stores therein recipient information, which is information about the recipient R. The recipient information includes, for example, various basic information such as the recipient's name, recipient name in the service, e-mail address, address, or phone number, account information for external applications, and payment information (such as credit card information). The storage unit 320 also stores therein one or more candidates for the proxy set in advance by the recipient R. The recipient information may also include the designation information described above. However, the recipient information is not limited to these items.

The storage unit 320 also stores information about the candidate for the proxy therein. The information about the candidate for the proxy includes, for example, the name of the candidate for the proxy, the name of the candidate for the proxy in the service, e-mail address, phone number, gender, age, and external application account information. The storage unit 320 may also store therein information about the pick-up of the package L by the candidate for the proxy. The information about the pick-up of the package L includes, for example, information about the status of participation in a predetermined training session related to the means of picking up the package L, the desired pick-up area, identification card information (including driver's license information), transfer account information, proxy pick-up history information, and the like. The predetermined training session related to the means of picking up the package L may be, for example, a training session to pick up the package L from an unmanned aircraft. However, the information about the candidate for the proxy is not limited to these items.

The storage unit 320 stores therein the recipient ID and the proxy ID, which are identification information for uniquely identifying the recipient R who uses the recipient's terminal 10 and the candidate for the proxy who uses the proxy's terminal 20.

The storage unit 320 also stores therein the information about the package L where the recipient R is designated in the address using the recipient's terminal 10. The information about the package L includes, for example, the identification information of the package L, the expected arrival time of the package L, whether the package L is a frozen commodity, whether the package L is a commodity that needs to be handled with care, such as “this side up”, “do not stack”, “perishable item”, or “fragile”, the delivery means of the package L, and so on. The information about the package L may also include information as to whether the proxy P is required to pick up the package L from the unmanned aircraft. It may also be possible to set the candidate for the proxy package by package, including the above-mentioned designation information, as the information about the package L.

The storage unit 320 also stores therein a database of the information about the identification information of the package L, the recipient R designated in the address of the package L, and the approved proxy P, who is able to pick up the package L. FIG. 6 is a diagram illustrating an example of the database stored in the storage unit 320. As illustrated in FIG. 6, the storage unit 320 stores therein the database that includes the recipient ID and the proxy ID linked to the package ID, which is the identification information of the package L. An authentication unit 332, which will be described in detail below, authenticates the pick-up of the package L on the basis of the database illustrated in FIG. 6.

### (Control Unit)

The control unit 330 controls the overall operation of the proxy authentication server 30. For example, the control unit 330 controls so that the information received from the recipient's terminal 10 and the proxy's terminal 20 by the communication unit 310 is stored in the storage unit 320. In the present embodiment, the control unit 330 has functions as a proxy approval unit 331 and the authentication unit 332.

### (Proxy Approval Unit)

The proxy approval unit 331 controls the communication unit 310 so as to transmit the information to the proxy's terminal 20 in accordance with the information received from the recipient's terminal 10. The proxy approval unit 331 also approves the proxy P in accordance with the information received from the proxy's terminal 20 by the communication unit 310.

When the communication unit 310 receives the designation information about the package L from the recipient's terminal 10, for example, the proxy approval unit 331 controls the communication unit 310 so as to transmit the proxy request to ask for the proxy pick-up of the package L to the proxy's terminal 20 used by the candidate for the proxy.

When the communication unit 310 receives the notification that the candidate for the proxy that is set in advance is designated as the candidate for the proxy about the package L from the recipient's terminal 10, the proxy approval unit 331 controls the communication unit 310 so as to transmit the proxy request to the proxy's terminal 20 used by the candidate for the proxy. When the communication unit 310 receives the notification that the pick-up of the package L is possible from the proxy's terminal 20 to which the proxy request has been transmitted, the proxy approval unit 331 approves the candidate for the proxy who uses the proxy's terminal 20, as the proxy P. This enables the recipient R to have a specific person pick up the package L on his/her behalf.

When the communication unit 310 receives the proxy support request regarding the package L from the recipient's terminal 10, the proxy approval unit 331 selects the candidate for the proxy. Instead of, or in addition to setting the type of candidate for the proxy by the designation information described above, the proxy approval unit 331 may select the candidate for the proxy who picks up the package L by proxy according to the positional information of the candidate for the proxy received from the proxy's terminal 20 by the communication unit 310. In other words, the proxy approval unit 331 may select the candidate for the proxy whose positional information is within a predetermined range from the pick-up position indicated by the information about the pick-up position and transmit the proxy request.

The proxy approval unit 331 may select the candidate for the proxy who picks up the package L by proxy with reference to the information about the package L and the information about the candidate for the proxy that are stored in the storage unit 320. For example, in a case where the storage unit 320 stores therein the information in which the proxy P picking up the package L from the unmanned aircraft is designated as the means of pick-up, the proxy approval unit 331 may select the candidate for the proxy stored in the storage unit 320 as the person who has taken the predetermined training session related to the means of picking up the package L, as the candidate for the proxy about the package L.

The proxy approval unit 331 controls the communication unit 310 so as to transmit the notification of the proxy recruitment to the proxy's terminal 20 used by the selected candidate for the proxy. The notification of the proxy recruitment may include the information about the package L. The candidate for the proxy can determine whether to pick up the package L by proxy by checking the information about the package L.

The notification of the proxy recruitment may include reward information. The reward information is information about the reward that the candidate for the proxy, as the proxy P, can obtain by picking up the package L on behalf of the recipient R. The reward may be money, a service, or points of monetary value, etc. The content of the reward may be determined by the recipient R who uses the recipient's terminal 10 that has transmitted the proxy support request, or may be a predetermined content (e.g., the reward content that is common among proxies, or the reward content based on the result of the proxy's past substitution, the reward content based on information related to the package, such as the weight of the package).

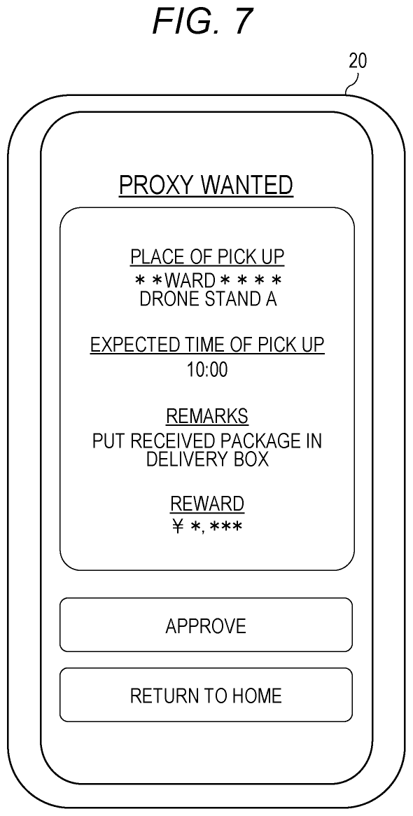

FIG. 7 is a diagram illustrating an example of the notification of the proxy recruitment transmitted to the proxy's terminal 20. As illustrated in FIG. 7, the notification of the proxy recruitment includes information such as the pick-up position of the package L, the expected time of pick-up, remarks (e.g., action after pick-up as illustrated in FIG. 7), and reward. The candidate for the proxy can also transmit the notification to the proxy authentication server 30 that the proxy pick-up of the package L is possible by performing an approval operation, such as selecting an approval button displayed on the proxy's terminal 20. This allows the recipient R to have someone pick up the package L on his/her behalf, even if there is no specific person the recipient R can ask to pick up the package L on his/her behalf.

If the candidate for the proxy, after checking the information displayed on the proxy's terminal 20, thinks that the information does not meet his/her requirement, the candidate may reject the proxy recruitment by performing a non-approval operation, such as selecting the home button or selecting a button indicating a non-approval.

When the communication unit 310 receives the notification that the pick-up of the package L is possible from the proxy's terminal 20 to which the notification of the proxy recruitment has been transmitted, the proxy approval unit 331 approves the candidate for the proxy who uses the proxy's terminal 20, as the proxy P. In a case where the confirmation notification is sent to the recipient and the recipient operates the approval operation for the confirmation notification before the approval, the proxy approval unit 331 may perform the approval in accordance with this, or the proxy approval unit 331 may perform the approval without such an approval operation by the recipient.

The communication unit 310 may also transmit the notification of the proxy recruitment to the candidates of the proxy. In this case, the proxy approval unit 331 may select one proxy from the candidates of the proxy. For example, the proxy approval unit 331 may approve as the proxy P, the candidate for the proxy who uses the proxy's terminal 20 to which the notification of the proxy recruitment or the notification that the pick-up of the package L is possible is transmitted first.

### (Authentication Unit)

The authentication unit 332 performs the authentication process to determine whether the request for the pick-up authentication of the delivered package L is from the proxy P who is approved by the proxy approval unit 331. The authentication unit 332, for example, performs the authentication process when the communication unit 310 receives the authentication request from the proxy's terminal 20. The authentication unit 332 performs the authentication process by comparing the package ID with the proxy ID with reference to the database stored in the storage unit 320. If it has been confirmed that the package ID included in the authentication request is linked to the proxy ID of the proxy P who uses the proxy's terminal 20, the authentication unit 332 determines that the request for the pick-up authentication of the package L is the request from the approved proxy P. In this case, the authentication unit 332 determines that the authentication has succeeded. On the other hand, if it has been confirmed that the package ID is not linked to the proxy ID of the proxy P, the authentication unit 332 determines that the request for the pick-up authentication of the package L is not authenticated by the approved proxy P. In this case, the authentication unit 332 determines that the authentication has failed.

The authentication unit 332 may also authenticate the proxy P in response to the authentication request from the proxy's terminal 20 based on the identification information related to the keeping device 40. In such a case, the received identification information related to the keeping device 40 needs to be linked to the package ID of the package L kept by the keeping device 40. Therefore, in the case where the authentication unit 332 performs the authentication on the basis of the identification information related to the keeping device 40, when the package L is kept in the keeping device 40, the identification information related to the keeping device 40 and the package ID of the package L are linked to each other and stored in the database stored in the storage unit 320. In the case where it has been confirmed that the package ID of the package L linked to the identification information related to the keeping device 40 included in the authentication request is linked to the proxy ID of the proxy P who uses the proxy's terminal 20, the authentication unit 332 determines that the authentication has succeeded.

When the authentication unit 332 determines that the pick-up authentication of the delivered package L is successful, the keeping device 40 is controlled so that the package L can be taken out of the keeping device 40 where the package L is kept, via the communication unit 310.

According to such a structure, the smooth pick-up of the package L by the proxy P can be realized. In a case where the package L is managed by a package manager not through the keeping device 40, the authentication request may be transmitted from the proxy's terminal 20 to a package manager's terminal (not illustrated) to initiate the authentication process in the proxy authentication server 30 via the package manager's terminal, the identification information (for example, various kinds of information codes including a bar code and a two-dimensional code) for the authentication request acquired from the proxy authentication server 30 by one of the proxy's terminal 20 and the package manager's terminal is read by the other with a camera or the like to initiate the authentication process in the authentication unit 332, or various kinds of information codes printed on or affixed to the package L may be read by the reading unit of the proxy's terminal 20 to initiate the authentication process in the authentication unit 332.

### 2-4. Example of Functional Configuration of Keeping Device 40

The example of the functional configuration of the proxy authentication server 30 according to the embodiment of the present invention has been described above. Next, an example of the functional configuration of the keeping device 40 is described.

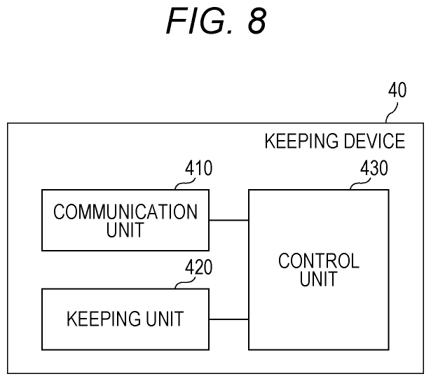

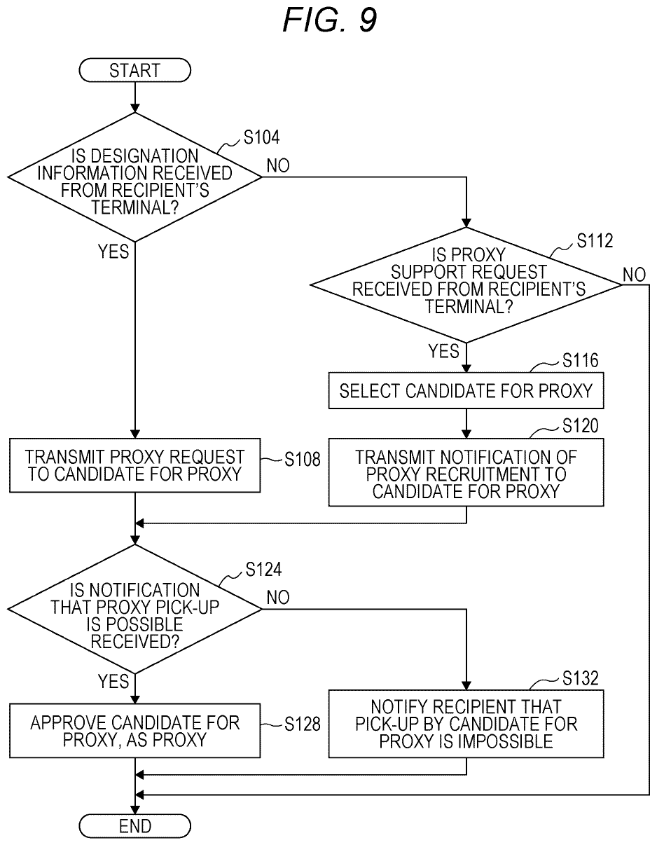

FIG. 8 is an explanatory diagram illustrating an internal structure of the keeping device 40. As illustrated in FIG. 8, the keeping device 40 includes a communication unit 410, a keeping unit 420, and a control unit 430.

### (Communication Unit)

The communication unit 410 communicates with the proxy authentication server 30 via the network 50. For example, the communication unit 410 receives an instruction for controlling the keeping unit 420 from the proxy authentication server 30.

### (Keeping Unit)

The keeping unit 420 keeps the package L where the recipient R is designated in the address. The keeping unit 420 enables the proxy P to take out the package L on the basis of the control instruction received from the proxy authentication server 30 by the communication unit 410. For example, the keeping unit 420 may have a box shape in which the package L can be accommodated, and have a lid that can be opened and closed. In this case, the keeping unit 420 may allow the proxy P to take out the package L by permitting the opening of the lid. The keeping unit 420 may keep the package L in such a way that the package L is fixed by a belt, a frame, or other fixing object. In such a case, the keeping unit 420 may allow the proxy P to take out the package l by releasing a part of the fixing object. The structure of the keeping unit 420 is not limited to these examples and it is only necessary that the package L is kept.

### (Control Unit)

The control unit 430 controls the overall operation of the keeping device 40. For example, the control unit 430 controls the keeping unit 420 so that package L can be taken out of the keeping unit 420 in accordance with the control instruction of the keeping unit 420 received from the proxy authentication server 30 by the communication unit 410.

### 3. Example of Operation Processing in Present Embodiment

The examples of the functional configurations in the present embodiment according to the embodiment of the invention have been described above. Subsequently, an example of operation processing according to the present embodiment is described.

Here, the recipient R, the candidate for the proxy, and the proxy P, provided by the present information processing system, access the proxy authentication server 30 using an application (including a web browser) or the like, and if they use the service for the first time, they may log in the service through a registration process. If the user already has an account, the user may be able to use the service by logging in after prescribed authentication, for example, by entering the user ID or recipient ID and a password. Instead of the account, a unique application ID related to the application downloaded on the recipient's terminal 10 or the proxy's terminal 20 may be used as the user ID or the recipient ID to enable the service use. After this login authentication, the service use is initiated via the application (including web browser), etc.

### (Procedure of Proxy Approval)

First, a procedure of the proxy approval by the proxy authentication server 30 is described. FIG. 9 is an explanatory diagram for describing an example of the procedure of the operation processing of the proxy approval by the proxy authentication server 30 according to the present embodiment. First, upon the reception of the designation information, which is the designation of the candidate for the proxy, from the recipient's terminal 10 (Yes at S104), the communication unit 310 transmits the proxy request to the proxy's terminal 20 used by the designated candidate for the proxy (S108).

On the other hand, if the designation information is not received from the recipient's terminal 10 (No at S104), the proxy approval unit 331 determines whether the communication unit 310 receives the proxy support request from the recipient's terminal 10 (S112). If the communication unit 310 receives the proxy support request from the recipient's terminal 10 (Yes at S112), the proxy approval unit 331 selects the candidate for the proxy (S116). The communication unit 310 then transmits the notification of the proxy recruitment to the proxy's terminal 20 used by the selected candidate for the proxy (S120).

On the other hand, if the communication unit 310 does not receive the proxy support request from the recipient's terminal 10 (No at S112), the proxy authentication server 30 terminates the process. When the communication unit 310 transmits the proxy request (S108) or the communication unit 310 transmits the notification of the proxy recruitment (S120), the proxy approval unit 331 determines whether the communication unit 310 receives the notification that the proxy pick-up is possible from the proxy's terminal 20 (S124). If the communication unit 310 receives the notification that the proxy pick-up is possible from the proxy's terminal 20 (Yes at S124), the proxy approval unit 331 approves the candidate for the proxy as the proxy P (S128), and the proxy authentication server 30 terminates the process. Upon the reception of the notification that the proxy pick-up is impossible from the proxy's terminal 20 (No at S124), the communication unit 310 transmits the notification that the proxy pick-up by the candidate for the proxy is impossible, to the recipient's terminal 10 used by the recipient R (S132), and the proxy authentication server 30 terminates the process.

### (Procedure of Authentication Process)

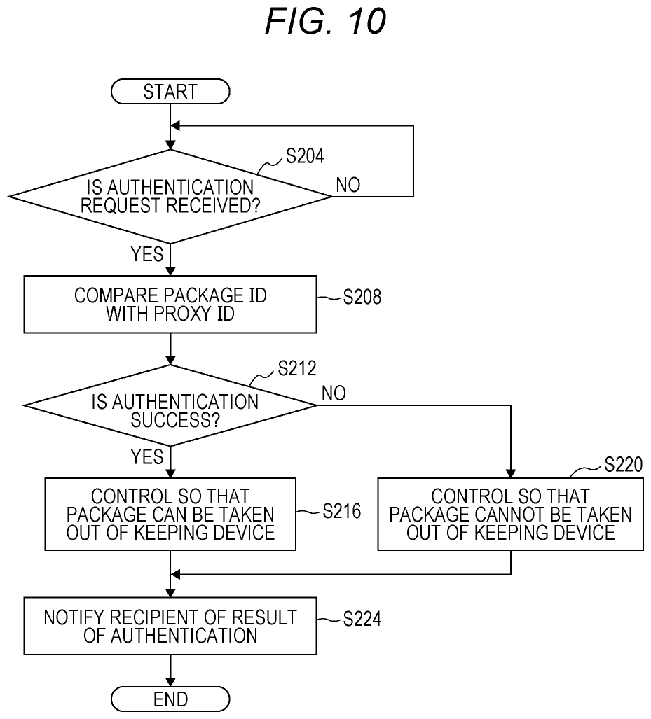

The procedure of the authentication of the proxy by the proxy authentication server 30 is described next. FIG. 10 is an explanatory diagram for describing an example of the procedure of the operation processing of the authentication process by the proxy authentication server 30 according to the present embodiment. It is assumed here that the package L is kept in such a way that the package L cannot be taken out of the keeping device 40.

First, the authentication unit 332 determines whether the communication unit 310 receives the authentication request from the proxy's terminal 20 (S204). If the communication unit 310 does not receive the authentication request from the proxy's terminal 20 (No at S204), the authentication unit 332 controls the keeping device 40 to continue keeping the package L so that the package L cannot be taken out of the keeping device 40.

On the other hand, if the communication unit 310 receives the authentication request from the proxy's terminal 20 (Yes at S204), the authentication unit 332 compares the package ID included in the authentication request by the communication unit 310 with the proxy ID of the proxy P who uses the proxy's terminal 20 (S208). The authentication unit 332 determines whether the authentication is successful based on the result of comparison (S212). If the package ID and the proxy ID match, the authentication unit 332 determines the authentication to be successful (Yes at S212) and controls the keeping device 40 to enable the package L to be taken out of the keeping device 40 (S216). On the other hand, if the package ID and the proxy ID do not match, the authentication unit 332 determines the authentication not to be successful (No at S212) and controls the keeping device 40 so that the package L continues being kept in such a way that the package L cannot be taken out of the keeping device 40 (S220). After the control of the keeping device 40 by the authentication unit 332, the communication unit 310 transmits the result of authentication to the recipient's terminal 10 used by the recipient R (S224), and the proxy authentication server 30 terminates the process.

### 4. Modification of Present Embodiment

The operation example of the proxy authentication server 30 by the present embodiment has been described above. The art described in the present disclosure is not limited to the embodiments described above. First, the additional functions of the communication unit and the control unit among the components of the keeping device 40 according to this modification will be described.

The communication unit 410 in this modification further has a function as an authentication communication unit that can communicate directly with the proxy's terminal 20. The communication method used for the communication with the proxy's terminal 20 is not limited in particular and may be, for example, short-range wireless communication such as Bluetooth (registered trademark), wireless LAN, or Wi-Fi. The communication unit 410 receives from the proxy's terminal 20, the authentication request including the proxy ID of the proxy P who uses the proxy's terminal 20.

The control unit 430 in this modification additionally has a function as an authentication unit that performs the authentication process to determine whether the request for the pick-up authentication of the delivered package L is a request from the proxy P who is approved by the proxy authentication server 30. The control unit 430 stores therein the proxy ID of the approved proxy P who can pick up the package L kept in the keeping device 40 by proxy.

The proxy ID may be transmitted in advance from the proxy authentication server 30 to the communication unit 410, or may be stored when the package L is kept in the keeping device 40.

The control unit 430 controls the keeping unit 420 so that package I can be taken out of the keeping unit 420 when the stored proxy ID matches the proxy ID received from the proxy's terminal 20 by the communication unit 410.

According to the information processing system in this modification, the package L can be controlled to be taken out of the keeping device 40 without communication with the proxy authentication server 30 at the time of the authentication of the proxy P. Therefore, in a case where the keeping device 40 is an unmanned vehicle, when the unmanned vehicle stops at a location where the communication with the proxy authentication server 30 is not possible, the proxy P can also pick up the package L after the authentication.

### 5. Hardware Configuration

The information processing described above is achieved through cooperation between software and hardware of the proxy authentication server 30 to be described below. The hardware configuration to be described below is also applicable to the recipient's terminal 10, the proxy's terminal 20, and the keeping device 40.

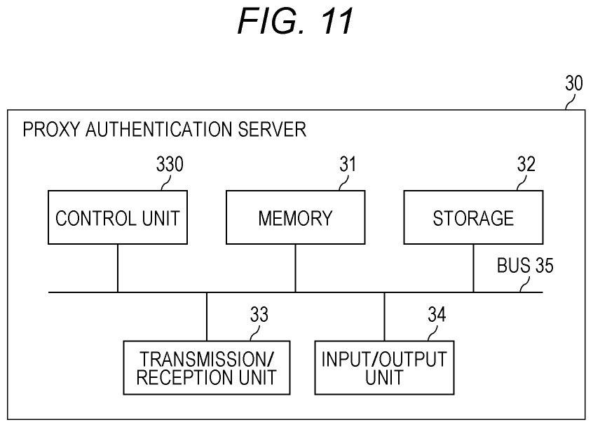

FIG. 11 is an explanatory diagram for describing an example of the hardware configuration of the proxy authentication server 30 according to the present embodiment. The proxy authentication server 30 includes the control unit 330, a memory 31, a storage 32, a transmission/reception unit 33, an input/output unit 34, and the like, which are electrically connected to each other through a bus 35 as illustrated in FIG. 11, for example.

The control unit 330 is an arithmetic unit that controls the overall operation of the proxy authentication server 30, controls the transmission and reception of data between the components, performs information processing necessary for the application execution and the authentication process, and so on. For example, the control unit 330 is a central processing unit (CPU) and/or a graphics processing unit (GPU), which executes programs for this system stored in the storage 32 and developed in the memory 31, for example, to perform various kinds of information processing as described above.

The memory 31 includes a main memory, which is composed of a volatile storage device such as dynamic random access memory (DRAM), and a secondary memory, which is composed of a non-volatile storage device such as a flash memory or a hard disc drive (HDD). The memory 31 is used as a work area for the control unit 330, for example, and also stores therein the basic input/output system (BIOS), which is executed when the proxy authentication server 30 is started, various kinds of setting information, and the like.

The storage 32 stores various programs such as application programs. The database storing the data used for each process may be constructed in the storage 32.

The transmission/reception unit 33 connects the proxy authentication server 30 to a network and/or a blockchain network. The transmission/reception unit 33 may include a short-range communication interface such as Bluetooth (registered trademark) and Bluetooth low energy (BLE).

The input/output unit 34 corresponds to an information input device such as a keyboard, a microphone, or a mouse, or an output device such as a display or a speaker.

The bus 35 is commonly connected to each of the above-described components and transmits, for example, address signals, data signals, and various control signals.

### 6. Supplement

The preferred embodiments of the present invention have been described above in detail with reference to the accompanying drawings; however, the present invention is not limited to such examples. It is readily apparent to those having ordinary knowledge and skilled in the art to which the present invention belongs that various modifications and substitutions can be made without departing from the technical spirit and scope of the appended claims, and that those naturally fall within the technical scope of the present invention.

For example, the package L is kept in the keeping device 40 in the above embodiment; however, the present invention is not limited to this example. In another example, the package L may be placed at a predetermined location such as a departure and arrival point for a mobile body such as a truck or unmanned vehicle that has delivered the package L. In this case, the communication unit 310 transmits the result of authentication to the recipient's terminal 10 after the authentication by the authentication unit 332. According to such a structure, the smooth pick-up of the package L by the proxy can be achieved more simply.

In this case, the proxy's terminal 20 may read the identification information from the information code displayed on the screen or printed at the departure and arrival point for the mobile body. The identification information read by the proxy's terminal 20 may be identification information related to the predetermined location. When it is determined that the package L is to be placed at the predetermined location, the identification information and the package ID are linked to each other and stored in the database of the storage unit 320, thereby enabling the authentication by the authentication unit 332.

The package L may also be deposited with a package manager who manages the package L. In such a case, when the authentication is successful, the communication unit 410 transmits the notification of the authentication completion to an information processing terminal used by the package manager who manages that package L. The package manager is a person, for example, an employee of a convenience store, a manager of the departure and arrival point for a mobile body, or an organizer of a neighborhood association. By checking the notification of such authentication completion, the package manager can recognize that the person who wants to pick up the package L is the approved proxy P. The proxy P can receive the package L from the manager. According to such a structure, the smooth pick-up of the package L by the proxy can be realized more simply, because the control of taking out of the package L is not required. In addition, compared to the aforementioned structure in which the package L is placed at the predetermined location, it is possible to eliminate the risk of the package L being taken away, for example.

In addition, it is also possible to create a computer program to make the hardware such as a CPU, a ROM, and a RAM incorporated in the recipient's terminal 10, the proxy's terminal 20, the proxy authentication server 30, and the keeping device 40 achieve the functions equivalent to the respective structures of the recipient's terminal 10, the proxy's terminal 20, the proxy authentication server 30, and the keeping device 40 describe above.

### REFERENCE SIGNS LIST

10 Recipient's terminal
20 Proxy's terminal
30 Proxy authentication server
40 Keeping device
50 Network
110 Communication unit
120 Operation display unit
130 Control unit
210 Sensor unit
220 Reading unit
230 Operation display unit
240 Control unit
310 Communication unit
320 Storage unit
330 Control unit
331 Proxy approval unit
332 Authentication unit
410 Communication unit
420 Keeping unit
430 Control unit

1. An information processing system comprising:
a control unit that approves a candidate for a proxy who is able to pick up a package on behalf of a recipient designated in an address of the package, as the proxy; and
an authentication unit that performs an authentication process of determining whether a request for pick-up authentication of the package that is delivered is a request from the proxy who is approved by the control unit.

2. The information processing system according to claim 1, further comprising a communication unit that receives a notification as to whether proxy pick-up of the package is possible from an information processing terminal used by the candidate for the proxy.

3. The information processing system according to claim 2, wherein when the communication unit receives the notification that pick-up of the package is possible from the information processing terminal used by the candidate for the proxy, the control unit approves the candidate for the proxy as the proxy.

4. The information processing system according to claim 2, wherein the communication unit receives designation information that is designation of the candidate for the proxy from an information processing terminal used by the recipient.

5. The information processing system according to claim 2, wherein the communication unit transmits a proxy request to ask for proxy pick-up of the package designated by the recipient.

6. The information processing system according to claim 2, wherein the communication unit transmits information about the package to the information processing terminal used by the candidate for the proxy.

7. The information processing system according to claim 5, further comprising a storage unit that stores therein one or a plurality of candidates for the proxy set in advance by the recipient, wherein
the communication unit transmits the proxy request to ask the candidate for the proxy stored in the storage unit to pick up the package by proxy.

8. The information processing system according to claim 7, wherein the communication unit transmits the proxy request to the candidate for the proxy selected by the recipient, among the candidates for the proxy stored in the storage unit.

9. The information processing system according to claim 2, wherein upon reception of a proxy support request from the information processing terminal used by the recipient, the communication unit transmits a notification of proxy recruitment to the information processing terminal used by the candidate for the proxy.

10. The information processing system according to claim 9, wherein the communication unit transmits the notification of the proxy recruitment including reward information to the candidate for the proxy.

11. The information processing system according to claim 9, wherein the communication unit receives positional information of the candidate for the proxy, and transmits the notification of the proxy recruitment to the candidate for the proxy in accordance with the positional information.

12. The information processing system according to claim 9, wherein in a case where the proxy is designated to pick up the package from an unmanned aircraft, the communication unit transmits the notification of the proxy recruitment to a person who has taken a predetermined training session.

13. The information processing system according to claim 1, wherein when the authentication unit determines that the request for the pick-up authentication of the package is the request from the approved proxy, the control unit controls so that the package is able to be taken out of a keeping device that keeps the package.

14. The information processing system according to claim 13, wherein
the keeping device is an unmanned vehicle, and
when the authentication unit determines that the request for the pick-up authentication of the package is the request from the approved proxy, the control unit controls so that the package is able to be taken out of the unmanned vehicle.

15. The information processing system according to claim 13, wherein the keeping device keeps the package released from the unmanned vehicle.

16. The information processing system according to claim 13, wherein the keeping device includes
the authentication unit, and
an authentication communication unit that receives information about the authentication from the information processing terminal used by the proxy.

17. The information processing system according to claim 2, wherein
the communication unit receives identification information transmitted from the information processing terminal used by the proxy, and
the authentication unit performs authentication, based on the identification information.

18. The information processing system according to claim 13, wherein the authentication unit authenticates the proxy in response to an authentication request from the information processing terminal used by the proxy, based on identification information related to the keeping device.

19. The information processing system according to claim 2, wherein when the authentication unit determines that the request for the pick-up authentication of the package is the request from the approved proxy, the communication unit transmits a notification of authentication completion to an information processing terminal used by a person who manages the package.

20. The information processing system according to claim 2, wherein upon the authentication by the authentication unit, the communication unit notifies the recipient of a result of the authentication.

21. An information processing device comprising:
a control unit that approves a candidate for a proxy who is able to pick up a package on behalf of a recipient designated in an address of the package, as the proxy; and
an authentication unit that performs an authentication process of determining whether a request for pick-up authentication of the package that is delivered is a request from the proxy who is approved by the control unit.

22. An information processing method to be performed by a computer, the information processing method comprising:
approving a candidate for a proxy who is able to pick up a package on behalf of a recipient designated in an address of the package, as the proxy; and
performing an authentication process of determining whether a request for pick-up authentication of the package that is delivered is a request from the proxy who is approved.

23. A program causing a computer to function as:
a control unit that approves a candidate for a proxy who is able to pick up a package on behalf of a recipient designated in an address of the package, as the proxy; and
an authentication unit that performs an authentication process of determining whether a request for pick-up authentication of the package that is delivered is a request from the proxy who is approved by the control unit.
